(19) United States
(12) Patent Application Publication
(10) Pub. No.: US 2020/0217550 A1
(43) Pub. Date: Jul. 9, 2020

(54) HVAC INFRARED DETECTION SYSTEMS AND METHODS

(71) Applicant: Johnson Controls Technology Company, Auburn Hills, MI (US)

(72) Inventors: Andrew M. Boyd, Wichita, KS (US); Brian D. Rigg, Douglass, KS (US); Shawn A. Hern, Derby, KS (US); Cody J. Kaiser, Wichita, KS (US); Tom R. Tasker, Andover, KS (US); Shaun B. Atchison, Wichita, KS (US); Jedidiah O. Bentz, Wichita, KS (US); John W. Uerkvitz, Valley Center, KS (US); Aneek M. Noor, Wichita, KS (US); Drew H. Carlton, Wichita, KS (US)

(21) Appl. No.: 16/252,264

(22) Filed: Jan. 18, 2019

Related U.S. Application Data
(60) Provisional application No. 62/789,898, filed on Jan. 8, 2019.

(51) Int. Cl. F24F 11/89; F24F 11/74; F24F 11/80; F24F 11/64; F24F 11/52; G08B 17/00; G05B 19/042

(52) U.S. Cl. CPC F24F 11/89; F24F 11/74; F24F 11/80; F24F 2120/10; F24F 11/52; G08B 17/00; G05B 19/042; F24F 11/64

(57) ABSTRACT

The present disclosure relates to a heating, ventilation, and/or air conditioning (HVAC) system including a thermal light detector configured to detect a heat indication within a conditioned space. The HVAC system further includes a controller configured to receive feedback indicative of the heat indication from the thermal light detector and, based on the feedback, correlate the heat indication with a categorized event of a plurality of categorized events. The controller is further configured to adjust operation of the HVAC system based on the categorized event.

### CROSS-REFERENCE TO RELATED APPLICATION

This application claims priority to and benefit of U.S. Provisional Patent Application No. 62/789,898, entitled “HVAC INFRARED DETECTION SYSTEMS AND METHODS,” filed Jan. 8, 2019, which is herein incorporated by reference in its entirety for all purposes.

### BACKGROUND

The present disclosure relates generally to heating, ventilation, and/or air conditioning (HVAC) systems. Specifically, the present disclosure relates to infrared detection systems and method in HVAC systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as an admission of any kind.

A wide range of applications exist for HVAC systems. For example, residential, light commercial, commercial, and industrial systems are used to control temperatures and air quality in residences and buildings. Such systems often are dedicated to either heating or cooling, although systems are common that perform both of these functions. Very generally, these systems operate by implementing a thermal cycle in which fluids are heated and cooled to provide the desired temperature in a controlled space, typically the inside of a residence or building. Similar systems are used for vehicle heating and cooling, and as well as for general refrigeration. In many HVAC systems, conditioned spaces may include occasional, unexpected heat sources that may affect thermal conditions of the conditioned space.

### SUMMARY

The present disclosure relates to a heating, ventilation, and/or air conditioning (HVAC) system including a thermal light detector configured to detect a heat indication within a conditioned space. The HVAC system further includes a controller configured to receive feedback indicative of the heat indication from the thermal light detector and, based on the feedback, correlate the heat indication with a categorized event of a plurality of categorized events. The controller is further configured to adjust operation of the HVAC system based on the categorized event.

The present disclosure also relates to a heating, ventilation, and/or air conditioning (HVAC) system including a thermal sensor configured to detect heat sources within a conditioned space and a controller. The controller is configured to receive, from the thermal sensor, data indicative of a heat source within the conditioned space and determine thermal characteristics of the heat source based on the received data. The controller is further configured to correlate the heat source with a type of heat source of multiple types of heat sources based on the thermal characteristics adjust operation of the HVAC system based on the type of heat source.

The present disclosure further relates to a heating, ventilation, and/or air conditioning (HVAC) system including a thermostat having an infrared (IR) sensor configured to detect heat sources within a conditioned space and a controller. The controller is configured to receive data indicative of thermal characteristics of the heat sources. The thermal characteristics include temperatures of the heat sources, durations of time that the heat sources are present within the conditioned space, times of day that the heat sources are present within the conditioned space, shapes of the heat sources, locations of the heat sources relative to the conditioned space, or any combination thereof. The controller is further configured to identify the heat sources based on the thermal characteristics and adjust operation of the HVAC system based on identities of the heat sources.

### DRAWINGS

FIG. 1 is a perspective view of an embodiment of a heating, ventilation, and/or air conditioning (HVAC) system for building environmental management that may employ one or more HVAC units, in accordance with aspects of the present disclosure;

FIG. 2 is a perspective view of an embodiment of an HVAC unit that may be used in the HVAC system of FIG. 1, in accordance with aspects of the present disclosure;

FIG. 3 is a perspective view of an embodiment of a residential, split heating and cooling system, in accordance with aspects of the present disclosure;

FIG. 4 is a schematic view of an embodiment of a vapor compression system that may be used in an HVAC system, in accordance with aspects of the present disclosure;

FIG. 5 is a plan view of an embodiment of a building with an HVAC system that may utilize infrared sensors to detect heat sources, in accordance with aspects of the present disclosure;

FIG. 6 is a block diagram of an embodiment of a control system of the HVAC system of FIG. 5, in accordance with aspects of the present disclosure; and

FIG. 7 is a flow diagram of an embodiment of a control process for the HVAC system of FIG. 5, in accordance with aspects of the present disclosure.

### DETAILED DESCRIPTION

The present disclosure is directed to heating, ventilation, and/or air conditioning (HVAC) systems that regulate climate characteristics within a conditioned space, such as by supplying conditioned air, providing user communications, and/or enabling other auxiliary functions based on detected heat sources within the conditioned space. Particularly, the HVAC system may utilize infrared sensors (IR) sensors configured to detect heat sources within the conditioned space. Based on thermal characteristics of the heat sources, such as temperature, time, location, shape, and other factors of the heat source, the HVAC system may enable one or more functions of the HVAC system. For example, in some embodiments, upon detection of a heat source, the HVAC system may increase an airflow of conditioned air or decrease a temperature of conditioned air to prevent the heat source from heating a conditioned space. Depending on identification of the type of heat source, the HVAC system may also communicate with a fire alarm system, a security system, another auxiliary system, or may prompt users via a user interface to take or initiate one or more actions to address the presence of the heat source.

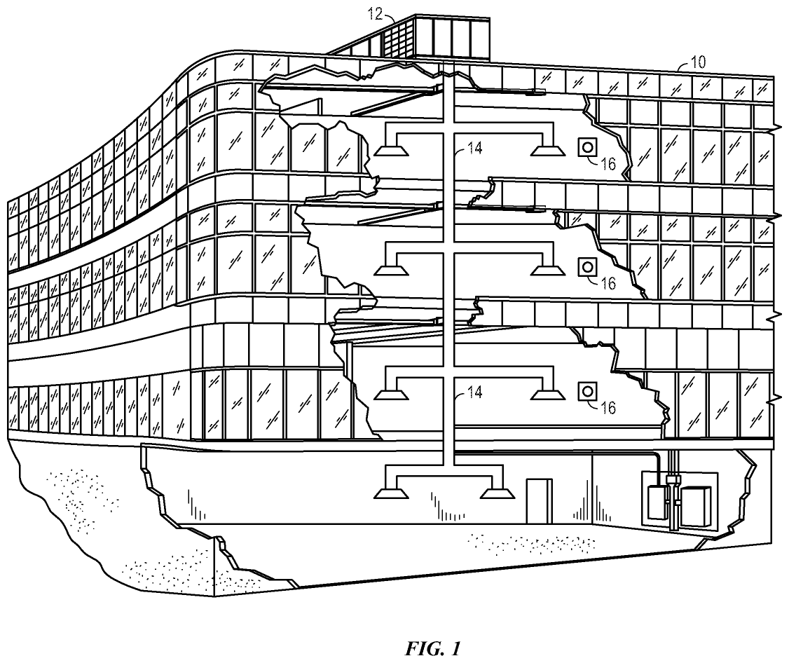

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

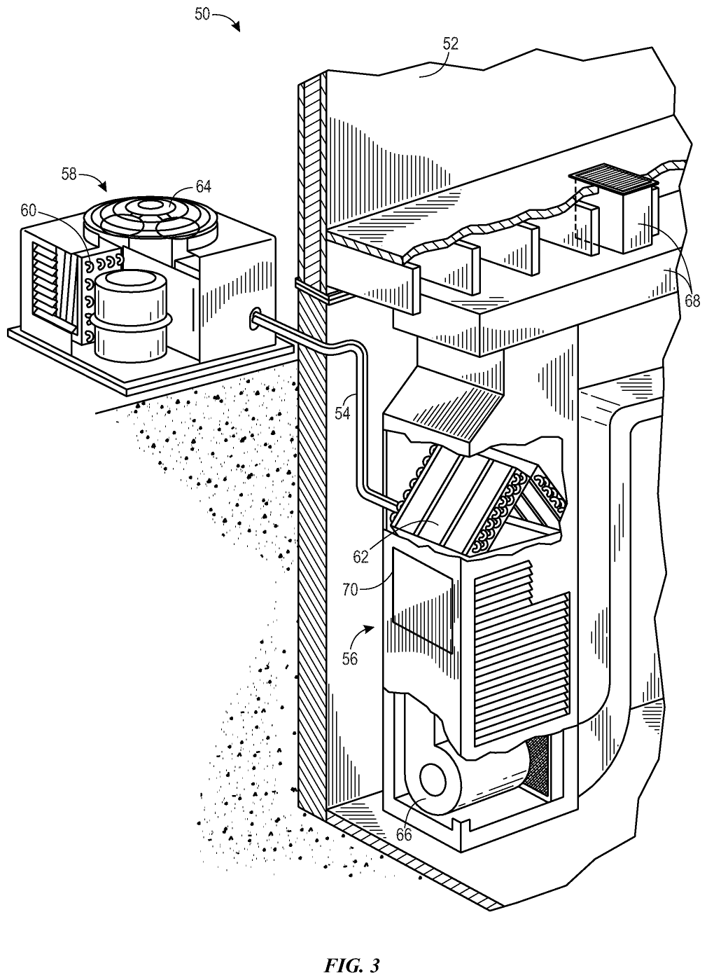

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.The HVAC unit 12 is an air cooled device that implements a refrigeration cycle to provide conditioned air to the building 10. Specifically, the HVAC unit 12 may include one or more heat exchangers across which an airflow is passed to condition the airflow before the airflow is supplied to the building. In the illustrated embodiment, the HVAC unit 12 is a rooftop unit (RTU) that conditions a supply air stream, such as environmental air and/or a return airflow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

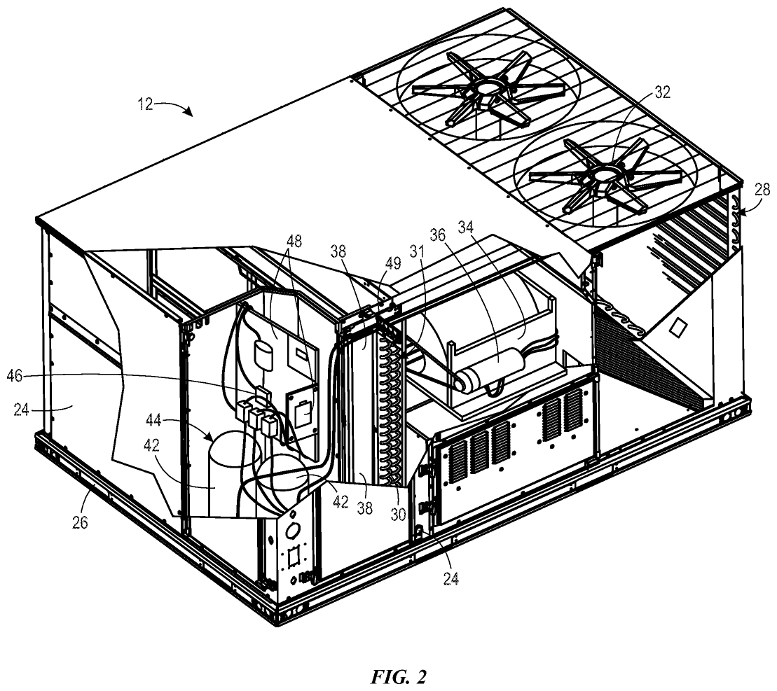

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the airflows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned airflows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

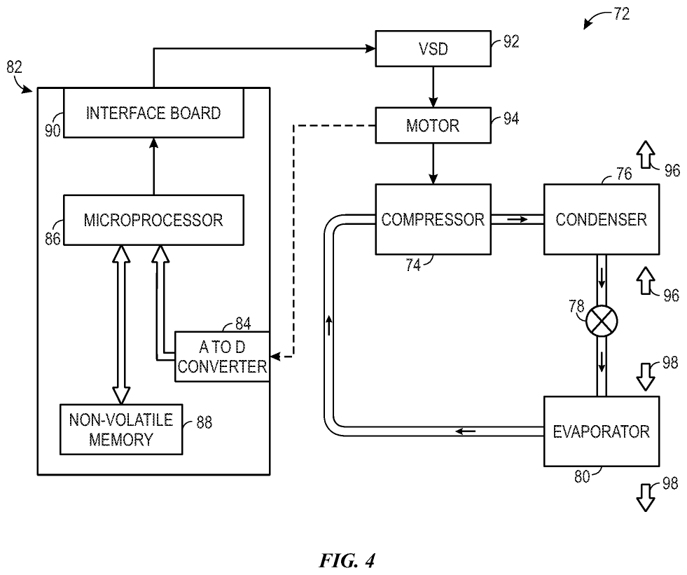

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed below, a heating, ventilation, and/or air conditioning (HVAC) system 100, such as the HVAC unit 12, the residential heating and cooling system 50, and/or the vapor compression system 72, may control one or more HVAC system 100 functions based on detection and/or identification of heat sources within a conditioned space serviced by the HVAC system 100. For example, based on the detection of heat sources, the HVAC system 100 may control a conditioned air flow, may provide communications, such as alerts or suggestions, to users via a user device, and/or may control functions of auxiliary systems, such as a security system, a fire alarm system, and/or other suitable systems.

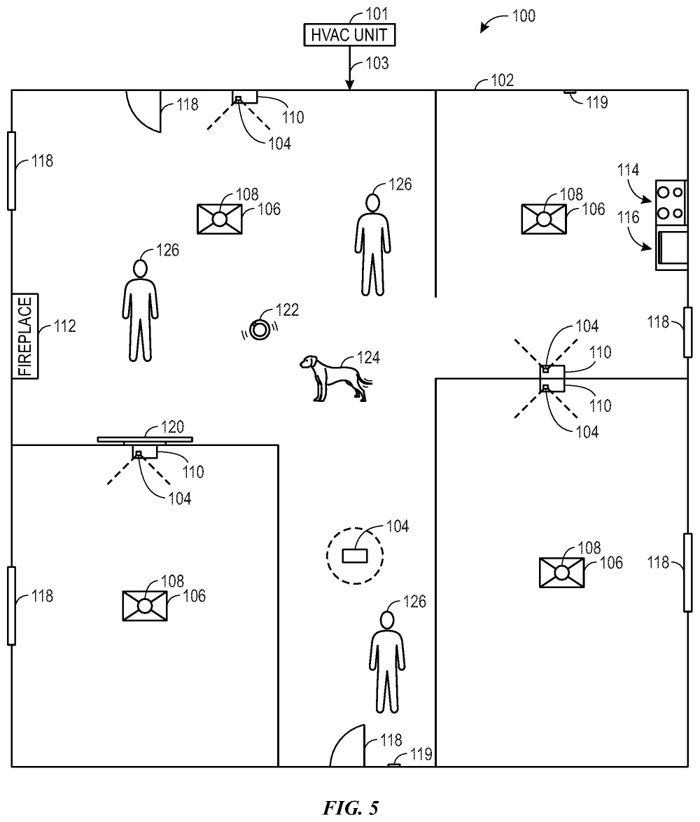

To illustrate, FIG. 5 is a plan view of a building 102 that may utilize the HVAC system 100 having thermal sensors 104, such as temperature sensors and/or thermal light detectors, such as infrared (IR) sensors, configured to detect heat sources, or heat indications, within the building 102. Thermal light detectors may include IR sensors, photodetectors, or any other suitable sensor configured to detect light, such as electromagnetic radiation having wavelengths within the infrared portion of the electromagnetic spectrum. More specifically, as used herein, thermal light detectors are sensors configured to detect wavelength gradients of electromagnetic radiation, such as within the infrared portion of the electromagnetic spectrum. In this way, data obtained from the thermal light detectors may be processed to determine temperature gradients of objects within a field of view of the thermal light detectors. In certain embodiments, the thermal sensors 104 may be passive infrared sensors (PIR) configured to detect infrared radiation emitted from objects within respective fields of view of the thermal sensors 104.

Generally, the HVAC system 100 may include an HVAC unit 101, such as the HVAC unit 12 or the heating and cooling system 50, configured to administer conditioned air 103 into the building 102 through outlets 106 of the HVAC system 100, such as air diffusers. Each outlet 106 and/or groups of outlets 106 may utilize an air control device 108, such as a variable air volume (VAV) box, which may control a volumetric flow rate of air as it passes through the outlet 106. Additionally, or in the alternative, the air control device 108 may include a reheat terminal, fan coils, and/or chilled beams to control a temperature of air as it passes through the outlet 106. Indeed, in certain embodiments, the HVAC system 100 may be a VAV system, which is configured to adjust a flow rate of the air, and/or may be a constant air volume (CAV) system, which is configured to adjust a temperature of the air as the air is conditioned and provided to the building 102 or conditioned space.

In some embodiments, the HVAC system 100 be a multi-zone HVAC system. That is, a control system of the HVAC system 100 may be configured to adjust operational parameters and/or properties of the HVAC system 100 to individually control the climate conditions in different zones, or areas, of the building 102. For example, the HVAC system 100 may respectively control the amount, direction, and/or temperature of a respective air flow provided to each zone of the HVAC system 100. In some embodiments, respective zones of the HVAC system 100 may be associated with certain rooms of the building 102. For example, one zone may be associated with a kitchen, another zone may be associated with a living room, a further zone may be associated with a master bedroom, and so forth. In some embodiments, each zone of the HVAC system 100 may include a thermostat 110, such as the control device 16, configured to control climate characteristics of the zone, or group of zones, of the building 102 in which the thermostat 110 is located. Indeed, each zone may be individually operated to have respective set point temperatures, mode settings, and so forth.

The HVAC system 100 may further include the thermal sensors 104 distributed throughout the building 102. In some embodiments, the thermal sensors 104 may be incorporated in, or integral to, the thermostats 110. That is, a portion or all of the thermostats 110 may include the one or more of the thermal sensors 104 configured to detect heat sources via IR detection. In some embodiments, the HVAC system 100 may include thermal sensors 104 disposed separately from the thermostats 110. Indeed, the distribution and amount of thermal sensors 104 placed throughout the building 102 may depend at least in part on operational parameters or specifications of the thermostats 110. For example, each thermal sensor 104 may be associated with a field of view and a range or distance in which the thermal sensor 104 is designed to accurately/reliably detect heat sources. Accordingly, the thermal sensors 104 may be placed throughout the building 102 such that the thermal sensors 104 are configured to provide adequate coverage of thermal monitoring throughout the building 102. In other words, the thermal sensors 104 may be placed throughout the building 102 such that the thermal sensors 104 are configured to accurately monitor a portion, a majority, or an entirety of the floors and walls of the building 102 for heat sources. Indeed, it should be noted that, although the illustrated distribution of thermal sensors 104 within the building 102 has been intentionally simplified to highlight certain aspects of the disclosure, the HVAC system 100 may include any suitable number and placement of thermal sensors 104. As used herein, accurate monitoring/detection of heat sources may refer to the ability of the thermal sensors 104 to detect a temperature, a size, a shape, a location, and behavior/movement of the heat sources.

The thermal sensors 104 are configured to detect a variety of heat sources, which may be located in a variety of locations throughout the building 102. Further, it should be noted that, as used herein, heat sources may refer to objects having a higher temperature than a set point temperature, objects having a lower temperature than the set point temperature, and/or objects that have any thermal gradient relative to a surrounding environment that is detectable by the thermal sensors 104. For example, in some embodiments, the heat sources may refer to any objects associated with a thermal gradient that may cause a measured temperature of a zone or area to migrate away from, such move above or below, a predetermined set point temperature. Accordingly, heat sources within the building 102 may include a fireplace 112, a stove/oven 114, kitchen or home appliances 116, such as water heaters, blenders, coffee machines, hot plates, microwaves, freezers/refrigerators, and so forth, portals 118, such as windows or doors, electrical devices, such as electrical outlets and/or light switches, entertainment devices 120, animate objects 122, such as mobile vacuum cleaners, pets 124, or other animals, humans 126, and other heat sources that emit thermal energy.

As mentioned above, the thermal sensors 104 are configured to detect thermal characteristics of the heat sources within the building 102. Thermal characteristics of the heat sources may include, for example, a temperature of the heat source, an amount of time, or time period, in which the heat source is present, a time of day in which the heat source is present, a shape or size of the heat source, movement of the heat source, a location of the heat source relative to the building, or any combination thereof. As discussed herein, a control system of the HVAC system 100 may receive data indicative of the thermal characteristics of the heat sources, and may correlate or categorize the heat sources with events, such as categorized events based on the thermal characteristics. In other words, the control system may identify the heat source or heat indication as a type or subset of heat source and/or may categorize the heat source as one of a plurality of categorized events. For example, in some embodiments, the control system may categorize the heat source as a typical or expected event. In such instances, the control system may continue operation of the HVAC system 100 or other building 102 systems as normal. Further, in some embodiments, the control system may categorize the heat source as an atypical or unexpected event. In such instances, the control system may enable one or more functions of the HVAC system 100, such as to adjust control of the HVAC unit 101, as described in further detail below.

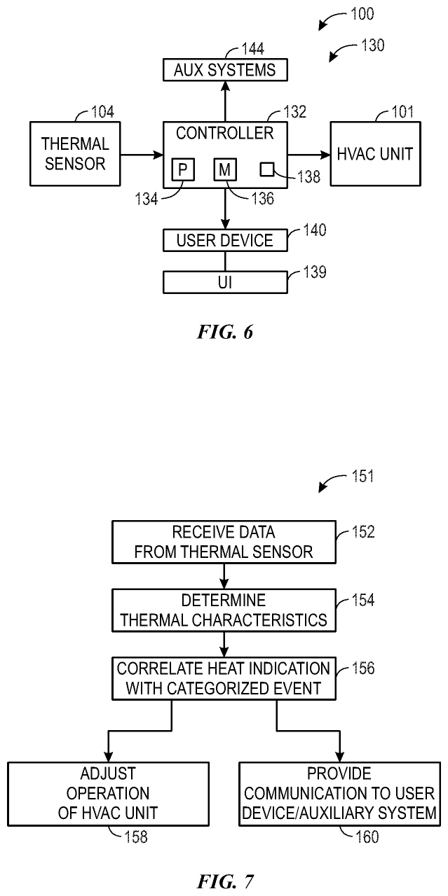

Keeping this in mind, FIG. 6 is a block diagram of an embodiment of a control system 130 of the HVAC system 100 and/or the building 102. Indeed, in some embodiments, the control system 130 may be communicatively coupled to a building automation system (BAS) of the building 102 and/or may be integral to the BAS. The control system 130 includes a controller 132. The controller 132 may employ a processor 134, which may represent one or more processors, such as an application-specific processor. The controller 132 may also include a memory device 136 for storing instructions executable by the processor 134 to perform the methods and control actions described herein for the HVAC system 100. The processor 134 may include one or more processing devices, and the memory 136 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium which can be used to carry or store desired program code in the form of machine-executable instructions or data structures and which can be accessed by the processor 134 or by any general purpose or special purpose computer or other machine with a processor. In some embodiments, the controller 132 may be included in a master or primary thermostat 110 of the HVAC system 100.

The control system 130 may further include communication circuitry 138 configured to provide intercommunication between the systems/components of the control system 130. In some embodiments, the communication circuitry 138 may communicate through a wireless network, such as wireless local area networks (WLAN), wireless wide area networks (WWAN), near field communication (NFC), Wi-Fi, and/or Bluetooth. In some embodiments, the communication circuitry 138 may communicate through a wired network such as local area networks (LAN), or wide area networks (WAN).

As illustrated, the controller 132 is configured to receive data from the thermal sensors 104. In some embodiments, as mentioned above, the controller 132 may receive the data from the thermal sensors 104 via the thermostat(s) 110 having the thermal sensors 104. The data received from the thermal sensors 104 may be indicative of heat sources or heat indications and the thermal characteristics thereof. For example, the thermal characteristics of the heat source may include a temperature, an occurrence time, a duration time, a size and/or shape, a location relative to the building 102, or a combination thereof, as mentioned above. The controller 132 may then correlate the heat sources with a categorized event based at least in part on the thermal characteristics. In other words, the controller 132 may identify the heat source as a certain type of heat source. As discussed in further detail below, the correlation of the heat sources with the categorized event may additionally or alternatively be based on previously cached data. The previously cached data may have been manually input, pre-programmed by a user, or learned, such as by machine learning, by the controller 132 based on historical data, or previous detections and/or identifications of heat sources.

Generally, a heat source may be identified as atypical/unexpected if the heat source is in an unexpected location of the building, if the heat source is at an unexpected temperature, if the heat source occurs at an unexpected time, if the heat source has unexpected movement/behavior, and so forth. As mentioned above, in some embodiments, a user may define expected thermal characteristics of spaces or areas within the building 102, which may thereby also define which thermal characteristics within the building 102 are unexpected. To illustrate, a user may define locations in the building 102 that may correspond to expected heat sources. For example, the defined location of expected heat sources may include the location of the stove/oven 114, the fireplace 112, or locations of other heat sources. Accordingly, if the thermal sensors 104 detect heat sources corresponding to the defined expected locations, the heat sources may be categorized as expected heat sources. Similarly, if a heat source is detected at a location that does not correspond to a defined, expected location, the heat source may be categorized as an unexpected heat source. As discussed in further detail below, the controller 132 may communicate with, or enable functions of, portions of the HVAC system 100 based on the identification of the heat sources and/or based on whether the heat source is expected/typical or unexpected/atypical.

To this end, in some embodiments, the controller 132 may be communicatively coupled to a user interface 139 which may be included in a user device 140, such as the thermostat 110, a computer, a smart phone, a tablet, or other personal user device. A user may manually input information to the controller 132 via the user interface 139. For example, the user may utilize the user interface 139 to input the previously cached data, which the controller 132 may utilize to categorize a heat source, such as being either expected or unexpected. To this end, the user interface 139 may include a display on which the controller 132 may provide messages to communicate with users, and may include input devices, such as touch screens, or other input devices, to receive input from the users.

Generally, the previously cached data may include data indicative of expected thermal characteristics that the user specifies or inputs via the user device 140. For example, a user, such as a system operator/installer, may input locations within the building 102 in which heat sources are expected to occur or exist. For example, the user may input locations of the stove/oven 114, portals 118, the fireplace 112, and so forth. Accordingly, if the thermal sensors 104 detect a heat source corresponding to the expected location manually input by the user, the controller 132 may categorize the heat source as an expected heat source and/or as a controlled heat source. Similarly, a user may input a time of day in which a heat source is expected to occur, such as when a human 126 or resident is expected to enter the building 102. Accordingly, if the thermal sensors 104 detect a heat source corresponding to the human 126 and corresponding to the manually input time of day associated with the arrival or presence of the human 126, the controller 132 may categorize the heat source as an expected heat source.

In some embodiments, the thermal sensors 104 may repeatedly detect a heat source with a particular set of thermal characteristics. For example, the thermal sensors 104 may continually detect the arrival of the human 126 into the building 102 at a certain time of day. The human 126 may include consistent thermal characteristics, such as a consistent shape, size, and temperature. Accordingly, due at least in part to the consistency of such heat sources, the controller 132 may utilize machine learning to determine that the consistent heat source is an expected heat source. In certain embodiments, the controller 132 may, upon determining that a heat source is consistent or reoccurring, prompt a user, via the user interface 139, to confirm that the heat source is expected.

In some embodiments, the controller 132 may enable one or more building functions of the building 102, such as by communicating with one or more portions of the HVAC system 100. As discussed in further detail below, the control/enablement of the one or more building functions and/or the communication with the one or more portions of the HVAC system 100 may be based at least in part on the categorization/identification of the heat source. The one or more portions of the HVAC system 100 may include, for example, the HVAC unit 101, a user device 140, and auxiliary systems 144, such as a security system, a fire alarm/detection system, a heat recovery ventilation (HRV) system, an energy, or enthalpy, recovery ventilation (ERV) system, or a combination thereof.

For example, based on data obtained from the thermal sensors 104, the controller 132 may determine that a heat source is present in the building 102. Particularly, the thermal characteristics of the heat source may indicate that thermal energy emitted by the heat source may cause a measured temperature of the building 102 or zone to migrate away from, such as above or below, a set point temperature of the building 102 or zone. Accordingly, the controller 132 may communicate with the HVAC unit 101 to cause the HVAC unit 101 to provide conditioned air to preemptively cool or heat the building 102 or zone based on the thermal characteristics of the detected heat source. For example, if a temperature of the heat source is a predetermined amount above the set point temperature, the controller 132 may communicate with the HVAC unit 101 to provide a cooling air flow generally towards the heat source so as to mitigate the thermal impact of the heat source within the building 102 or zone.

Similarly, if a temperature of the heat source is below the set point temperature, the controller 132 may communicate with the HVAC unit 101 to provide a warming air flow towards the heat source so as to similarly mitigate the thermal impact of the heat source within the building 102 or zone. Indeed, the controller 132 may generally cause the HVAC unit 101 to adjust operation to increase an airflow of provided conditioned air, decrease an airflow of provided conditioned air, increase a temperature of provided conditioned air, decrease a temperature of provided conditioned air, or a combination thereof to block heat sources from causing air stratification or to reduce an uneven distribution of temperatures within the building 102 or zone.

Further, in some embodiments, based on data received from the thermal sensors 104, the controller 132 may determine that a heat source within the building has potential to cause a fire within the building 102 or may identify the heat source as an uncontrolled heat source. Accordingly, based on the determination, the controller 132 may communicate with a fire alarm system of the auxiliary systems 144 to enable a fire alarm, which may include an audible alarm, a visual alarm, initiation of contact with local first responders, and so forth. In some embodiments, the controller 132 may contact local first responders or enable activation of an alarm independent of the auxiliary systems 144. Further, in some embodiments, upon identification/categorization/correlation of an uncontrolled heat source, the controller 132 may cause the HVAC unit 101 to discontinue a supply of air in order to block advancement of the uncontrolled heat source.

Similarly, in some embodiments, the controller 132 may determine that an unfamiliar person, such as a trespasser, is within the building 102 based on data received from the thermal sensors 104. Particularly, as discussed above, the heat source may include thermal characteristics indicative of the presence of humans 126 at an unexpected time, such as when residents of the building 102 are absent or the HVAC system 100 is in an away mode. Accordingly, in such instances, the controller 132 may communicate with a security system of the auxiliary systems 144 to enable predetermined protocols of the security system. Moreover, in some embodiments, the thermal sensors 104 may be utilized to determine the temperature levels of exhaust air that the HVAC system 100 expels from the building 102. To this end, the controller 132 may communicate with the ERV and/or HRV system of the auxiliary systems 144 to utilize exhaust air from the HVAC system 100 to heat or cool outdoor or fresh air depending at least in part on the temperature of the exhaust air detected with the thermal sensors 104.

The controller 132 may also communicate with the user device 140 based on the thermal characteristics of the heat sources detected by the thermal sensors 104. For example, in some embodiments, upon identification of a heat source, the controller 132 may prompt or communicate a message to a user via the user device 140 to take one or more actions. For example, the thermal sensors 104 may detect that one of the portals 118, such as a window or door, is ajar and leaking air. In such embodiments, identification of the portal 118 being ajar may be based on the thermal sensors 104 detecting that there is a transfer of thermal energy proximate the portal 118. Accordingly, the controller 132 may prompt the user, via the user device 140, to close the portal 118. As a further example, the thermal sensors 104 may detect excessive heat radiating from light bulbs, electrical outlets, or light switches. In such embodiments, the controller 132 may prompt the user, via the user device 140, to switch out light bulbs for more energy efficient bulbs or seek repairs for the electrical outlets and/or light switches.

FIG. 7 is a flow diagram of an embodiment of a control process 151 used to determine operations of the controller 132 in response to heat sources detected by the thermal sensors 104. At block 152, the controller 132 may receive data from the thermal sensors 104 indicative of thermal characteristics of heat sources or heat indications within a conditioned area, such as the building 102. In some embodiments, the data indicative of the thermal characteristics of the heat sources may be displayed via the user interface 139. That is, data may be displayed as a rendering of the location of the heat sources, a thermal gradient of the heat sources, and/or a shape of the heat sources. Indeed, in some embodiments, a visual representation of the data may be viewed as a live or real-time display of the heat sources within the conditioned area via the user interface 139.

At block 154, the controller 132 may determine the thermal characteristics of the heat sources based on the data received from the thermal sensors 104 as described in reference to block 152. Particularly, based on the data received from the thermal sensors 104, the controller 132 may determine the location within the conditioned space, such as the building 102, time of day, time duration, temperature, thermal intensity, movement, and/or shape of the heat source.

At block 156, the controller 132 may correlate the heat sources with a categorized event. In other words, the controller 132 may identify each heat source as a certain type of heat source. For example, as mentioned above, the heat source may be identified as or may be correlated to the fireplace 112, the stove/oven 114, kitchen appliances 116, such as water heaters, blenders, coffee machines, hot plates, microwaves, freezers/refrigerators, and so forth, the portals 118, such as windows or doors, the electrical outlets 119, the entertainment devices 120, the animate objects 122, such as mobile vacuum cleaners, the pets 124 or other animals, the humans 126, and/or other heat sources. Moreover, the heat source may be identified or categorized as a typical or atypical heat source. In other words, the heat source may be correlated with an expected or unexpected heat source based on data stored within the controller 132. As mentioned above, if the heat source is identified as atypical or unexpected the controller 132 may enable or trigger initiation of one or more functions of the HVAC system 100 or other operations associated with the building 102.

Generally, the controller 132 may categorize the heat source as a certain object or as fitting into a category of a group of objects within the building 102. Once the heat source is categorized, the controller 132 may determine whether the heat source is typical or atypical. Indeed, the identification of the heat source and whether the heat source is typical or atypical may be based on the thermal characteristics of the heat source. For example, the controller 132 may determine or categorize a particular heat source to be a kitchen appliance 116 based on the location, shape, temperature, and/or other thermal characteristics. The controller 132 may then further analyze the thermal characteristics to determine if the kitchen appliance 116 is typical or atypical. For example, if a temperature of the kitchen appliance 116 is determined to be above a predetermined temperature threshold, such as above a temperature that may be indicative of an uncontrolled heat source like a fire or an adverse thermal presence, the controller 132 may determine the kitchen appliance 116 to be atypical and may enable one or more building functions, such as alerting a user via the user device 140 or via triggering a fire alarm system of the auxiliary systems 144.

In some embodiments, identification of a heat source may be based on user inputs, historical data, or a combination thereof. For example, during set up of the HVAC system 100, a user or system operator may manually input or pre-program the locations of certain heat sources, such as the fireplace 112, the stove/oven 114, portals 118, and so forth. Accordingly, if the thermal sensors 104 detect a heat source located in a location previously associated with a particular or type of heat source via the user inputs, the controller 132 may determine the heat source to be the manually input heat source. Similarly, in some embodiments, the controller 132 may repeatedly determine a particular heat source to be in a specific location and within a certain temperature range, such as the stove/oven 114. Accordingly, in some embodiments, the controller 132 may prompt a user via the user device 140 to confirm identification of the heat source as the stove/oven 114. The controller 132 may then automatically identify the heat source 132 as the stove/oven 114 upon detection of a heat source having the identified characteristics in the future.

As discussed above, the controller 132 may determine a detected heat source to be the stove/oven 114. The controller 132 may then further determine the detected thermal characteristics to be atypical/unexpected if the stove/oven 114 is left unattended for a predetermined period of time while above a predetermined threshold temperature. For example, the controller 132 may also determine whether a human 126 is adjacent to the stove/oven 114 to determine whether the stove/oven 114 is unattended.

In some embodiments, the controller 132 may determine a detected heat source to be an uncontrolled heat source, such as a fire, based on the detected thermal characteristics. The controller 132 may then determine whether the heat source is typical or atypical based on the detected thermal characteristics. For example, the heat source identified as a fire may be determined to be typical and/or controlled if the detected heat source coincides with a location of the fireplace 112. As mentioned above, the location of the fireplace 112 may have been determined based on historical data or may have been determined based on a manual data entry by a user via the user interface 139. If the heat source identified as a fire does not coincide with the fireplace 112, the controller 132 may activate or communicate with a fire alarm system to initiate activation of the fire alarm system, for example.

Further, in some embodiments, the controller 132 may be unable to identify a heat source as a certain object. Indeed, in such embodiments, the detected thermal characteristics may not correspond to a known, or previously identified, heat source. In such instances, the controller 132 may categorize the detected heat source as within one or more categories of heat sources. For example, the controller 132 may determine that the temperature of the detected heat source is within one of multiple temperature ranges. In one embodiment, if the temperature of the detected heat source is within a first or lower temperature range, the controller 132 may categorize the heat source to be within a first category, which may include solar energy coming through a window, warm or cold air traveling through an open portal 118, and so forth. If the temperature of the detected heat source is within a second or medium temperature range, the controller 132 may categorize the detected heat source to be within a second category, which may include live heat sources, such as pets 124 or humans 126, some kitchen appliances 116, entertainment devices 120, and so forth. If the temperature of the detected heat source is within a third or higher temperature range, the controller 132 may categorize the detected heat source to be within a third category, which may include some kitchen appliances 116, the stove/oven 114, a fire, and so forth.

As a further example, the controller 132 may identify heat sources to be humans 126 based on the movement, shape, and temperature of the heat sources. In some embodiments, the determination of the heat source as a human 126 may be determined to be typical, such as if the owners/residents of the building 102 are also within the building 102. That is, if human 126 heat sources are determined to be in the building 102, the controller 132 may determine that the heat source is associated with a resident or a guest of the resident of the building 102. Indeed, in such embodiments, the controller 132 may communicate with a global positioning system (GPS), which may be associated with the user device 140, such as a smart phone, a smart watch, and so forth.

However, the controller 132 may determine the human 126 heat source to be atypical if the owners/residents are outside of the building 102 or are outside of a geofence, such as a predefined virtual, spatial boundary, which may coincide with the property area of the building 102. Similarly, in some embodiments, the controller 132 may determine the human 126 heat sources to be atypical if the HVAC system 100 set in an away mode or if the owners/residents indicate, such as through input via the user device 140, that no humans 126 should be within the building 102. Further, it should be noted that the controller 132 may be able to differentiate between pets 124 and trespassers. Indeed, although mammalian pets 124 and trespassers may be associated with similar temperatures, the general shape of heat sources associated with pets 124 and humans 126 may differ significantly. Accordingly, the controller 132 may be able differentiate between the shapes of the heat sources associated with pets 124 and humans 126 in order to avoid false alarms or inaccurate categorizations of heat sources.

Based on the categorization and/or identification of the heat source, the controller 132 may adjust operation of the HVAC unit 101, as indicated by block 158. Indeed, as discussed above, heat sources may have temperatures above or below a set point temperature of the building 102. That is, the heat source may cause a measured temperature of the building 102 to increase above or decrease below the set point temperature, which may cause air stratification within the conditioned space of the building 102. As an example, if the controller 132 determines that a heat source is providing heat to the building 102 during winter, the controller 132 may cause the HVAC unit 101 to stop providing heated air to one or more portions of the building 102 to conserve energy and to reduce overheating of the building 102. As a further example, the controller 132 may determine that a substantial number of people or humans 126 are within the building 102, such as for an event or party. Accordingly, in such embodiments, the controller 132 may determine that the detected heat source, such as the people, are likely to raise a measured temperature of the building 102. Thus, the controller 132 may adjust operation of the HVAC unit 101 to cause the HVAC unit 101 to lower a set point temperature of supply air, increase an airflow of supplied air, or a combination thereof, in order to maintain the measured temperature of the building 102 at the set point temperature. In other words, the controller 132 may cause the HVAC unit 101 to preemptively heat, cool, or discontinue operation, upon identification of the heat source in order to block the heat sources from increasing the measured temperature above or decreasing below the set point temperature. That is, operation of the HVAC unit 101 may be adjusted based on a potential of a heat source to cause a measured temperature of the conditioned space to increase above or decrease below the set point temperature.

In some embodiments, the controller 132 may adjust operation of the HVAC system 100 based on historical data, previously cached data, and/or user preferences. Particularly, in some embodiments, the controller 132 may utilize machine learning to track patterns in detected heat sources and adjust operation of the HVAC unit 101 accordingly. To illustrate, the controller 132 may, based on data received from the thermal sensors 104, determine that residents of the building 102 repeatedly arrive to the building 102 at a certain time on weekdays. Moreover, the users may repeatedly adjust a set point temperature of the HVAC system 100 upon arrival to the building 102. Accordingly, the HVAC system 100 may learn from the users' inputs and may automatically adjust the set point temperature upon arrival of the users into the building 102. Further, in some embodiments, the users may adjust the set point temperature based on seasonal cycles. Accordingly, the controller 132 may learn from the users' inputs and may automatically adjust the set point temperature based on the seasonal cycles and/or on the users' previous inputs as the user inputs relate to the time of year. Additionally or alternatively, the controller 132 may automatically adjust the set point temperature based on the seasonal cycles or other reoccurring events without input from the user.

The controller 132 may also provide communication with the user device 140 and/or auxiliary systems 144 based on the categorization and/or identification of the heat source, as indicated by block 160. For example, as discussed above, the controller 132 may determine that a heat source is associated with a human 126 and is unexpected. For example, the human 126 may be a trespasser. In such instances, the controller 132 may communicate with a security system to enable or activate one or more functions of the security system. Moreover, the controller 132 may alert a user of the identification of the trespasser via the user device 140.

As a further example, the controller 132 may determine that one of the portals 118, such as a window or door, is ajar based on detection of a transfer of thermal energy proximate the portal 118. In such embodiments, the controller 132 may notify a user via the user interface 139 to close the portal 118. Further, in some embodiments, the controller 132 may identify a heat source to be solar energy radiating through one of the portals 118. In such embodiments, if the HVAC system 100 is in a cooling mode, the controller 132 may prompt the user via the user interface 139 to adjust a window setting, such as by closing blinds, to block the solar energy from radiating through the portals 118 and heating the conditioned space within the building 102.

Moreover, in some embodiments, the controller 132 may identify a heat source to be a light bulb, light switch, or electrical outlet 119 that is at an above-average operating temperature. The above-average operating temperature may be predetermined based on standard operating temperatures for energy efficient light bulbs, which may be obtained from a lookup table stored in the memory 136, for example. For light switches and/or electrical outlets 119, the temperature may be determined to be above-average if the temperature is more than 10 degrees Fahrenheit, or other suitable temperature difference, above a set point temperature of the building 102. After the controller 132 determines that a light bulb, light switch, electrical outlet 119, or other object in the building 102 is at an atypical or above-average temperature, the controller 132 may prompt the user via the user device 140 to repair, replace, update, or turn off the light bulb, light switch, electrical outlet 119, or other object. In some embodiments, the controller 132 may prompt the user to switch to a more energy efficient light bulb if the controller 132 determines that a light bulb is at an above-average temperature.

Accordingly, the present disclosure is directed to utilizing thermal sensors, such as passive infrared (PIR) sensors, to detect heat sources within a conditioned space and to enable or activate one or more building functions of an HVAC system based on the detected heat sources. The thermal sensors may be included in thermostats spaced throughout the conditioned space or may be standalone. Generally, the heat source may be identified as, or may be correlated to, a certain type of heat source. In some embodiments, the heat source may be determined to be typical, such as a heat source that is standard or expected in the conditioned space, and may not substantially affect thermal conditions within the conditioned space. In some embodiments, the heat source may be determined to be atypical, such as a heat source that may affect thermal conditions within the conditioned space, or may otherwise be undesirable or unexpected. In some embodiments, one or more building functions may be enabled or activated based on the identification/correlation/categorization of the heat source. For example, operation of an HVAC system may be adjusted to account for the heat source, such as by adjusting a temperature or airflow of a supply of conditioned air. As a further example, security, fire alarm, or other systems may be enabled or activated if the heat source warrants as such. Additionally or alternatively, users may be notified of the heat source or prompted to respond to the heat source via a user interface of the HVAC system.

While only certain features and embodiments of the present disclosure have been illustrated and described, many modifications and changes may occur to those skilled in the art, such as variations in sizes, dimensions, structures, shapes and proportions of the various elements, values of parameters, such as temperatures or pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described, such as those unrelated to the presently contemplated best mode of carrying out the present disclosure, or those unrelated to enabling the claimed embodiments. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, and/or air conditioning (HVAC) system, comprising:
a thermal light detector configured to detect a heat indication within a conditioned space; and
a controller configured to receive feedback indicative of the heat indication from the thermal light detector and, based on the feedback, correlate the heat indication with a categorized event of a plurality of categorized events, and adjust operation of the HVAC system based on the categorized event.

2. The HVAC system of claim 1, wherein the controller is configured to receive manual data entry indicative of a subset of the plurality of categorized events, and wherein, based on the feedback, the controller is configured to correlate the heat indication with the subset of the plurality of categorized events.

3. The HVAC system of claim 2, wherein the subset of the plurality of categorized events is associated with particular locations within the conditioned space, and wherein the association between the subset of the plurality of categorized events and the particular locations is pre-programmed.

4. The HVAC system of claim 2, wherein the subset is a first subset, and a second subset of the plurality of categorized events is learned by the controller based on historical detections of a plurality of additional heat indications within the conditioned space.

5. The HVAC system of claim 4, wherein the second subset of the plurality of categorized events includes presence of human forms in the conditioned space, use of a home appliance in the conditioned space, or any combination thereof.

6. The HVAC system of claim 1, wherein the controller is configured to adjust operation of the HVAC system by adjusting a supply airflow speed and/or by adjusting a supply airflow temperature.

7. The HVAC system of claim 1, further comprising a thermostat, wherein the thermostat includes the thermal light detector.

8. The HVAC system of claim 1, wherein the plurality of categorized events includes use of a home appliance in the conditioned space, presence of an uncontrolled heat source in the conditioned space, transfer of thermal energy proximate a window, door, or other portal of the conditioned space, or any combination thereof.

9. The HVAC system of claim 1, wherein the thermal light detector is a passive infrared sensor.

10. The HVAC system of claim 1, wherein the controller is configured to activate a security system of the conditioned space based on the correlation of the heat indication with the categorized event.

11. The HVAC system of claim 1, wherein the controller is configured to activate a fire alarm system of the conditioned space based on the correlation of the heat indication with the categorized event.

12. The HVAC system of claim 1, wherein the controller is configured to display a visual representation of the feedback indicative of the heat indication via a user interface.

13. The HVAC system of claim 1, further comprising a user interface, wherein the controller is configured to notify a user of the categorized event via the user interface based on the categorized event.

14. The HVAC system of claim 13, wherein the controller is configured to prompt the user, via the user interface, to adjust a window setting based on the categorized event.

15. A heating, ventilation, and/or air conditioning (HVAC) system, comprising:
a thermal sensor configured to detect heat sources within a conditioned space; and
a controller configured to:
receive, from the thermal sensor, data indicative of a heat source within the conditioned space;
determine thermal characteristics of the heat source based on the received data;
correlate the heat source with a type of heat source of a plurality of types of heat sources based on the thermal characteristics; and
adjust operation of the HVAC system based on the type of heat source.

16. The HVAC system of claim 15, wherein the thermal sensor is an infrared sensor.

17. The HVAC system of claim 15, wherein the thermal characteristics of the heat source include a temperature of the heat source, a duration of time that the heat source is present, a time of day in which the heat source is present, a shape of the heat source, a location of the heat source within the conditioned space, or any combination thereof.

18. The HVAC system of claim 15, wherein the thermal characteristics of the heat source include a temperature of the heat source, and wherein correlation of heat source with the type of heat source is based on the temperature of the heat source.

19. The HVAC system of claim 15, wherein the plurality of types of heat sources includes an expected human within the conditioned space and an unexpected human within the conditioned space.

20. The HVAC system of claim 15, wherein the type of heat source is an uncontrolled type of heat source, and wherein the controller is configured to initiate communication with an alarm system based on the uncontrolled type of heat source.

21. The HVAC system of claim 15, wherein the thermal characteristics include a location of the heat source within the conditioned space, and the type of heat source is a controlled type of heat source, and wherein the controller is configured to correlate the heat source with the controlled type of heat source based on the location of the heat source within the conditioned space.

22. The HVAC system of claim 21, wherein the location of the heat source is pre-programmed in the controller by a user.

23. A heating, ventilation, and/or air conditioning (HVAC) system, comprising:
a thermostat having an infrared (IR) sensor configured to detect heat sources within a conditioned space; and
a controller configured to:
receive data indicative of thermal characteristics of the heat sources, wherein the thermal characteristics include temperatures of the heat sources, durations of time that the heat sources are present within the conditioned space, times of day that the heat sources are present within the conditioned space, shapes of the heat sources, locations of the heat sources relative to the conditioned space, or any combination thereof;
identify the heat sources based on the thermal characteristics; and
adjust operation of the HVAC system based on identities of the heat sources.

24. The HVAC system of claim 23, wherein the controller is configured to identify the heat sources based on data indicative of the thermal characteristics that is pre-programmed in the controller.

25. The HVAC system of claim 23, wherein the controller is configured to identify the heat sources based on historical data of previous occurrences of heat sources within the conditioned space.

26. The HVAC system of claim 23, comprising a user interface, wherein the controller is configured to display a message to a user via the user interface based on identification of the heat sources.

27. The HVAC system of claim 23, wherein the controller is configured to identify a heat source of the heat sources as above a predetermined threshold temperature, and wherein the controller is configured to adjust operation of the HVAC system to increase supply of conditioned airflow and/or to decrease a temperature of the conditioned airflow based on the heat source being above the predetermined threshold temperature.

28. The HVAC system of claim 23, wherein the controller is configured to identify each heat source of the heat sources as a type of heat source based on the thermal characteristics, wherein the type of heat source is as a fireplace, an oven, a kitchen appliance, a portal of the conditioned space, an electrical device, an entertainment device, a pet, a human, or any combination thereof.
